(19) United States
(12) Patent Application Publication
(10) Pub. No.: US 2010/0009094 A1
(43) Pub. Date: Jan. 14, 2010

(54) METHOD FOR THE PRODUCING STRUCTURED ELECTRICALLY CONDUCTIVE SURFACES

(75) Inventors: Rene Lochtman, Mannheim (DE); Jürgen Kaczun, Wachenheim (DE); Norbert Wagner, Mutterstadt (DE); Jürgen Pfister, Speyer (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE Patents, Trademarks and Licenses, Ludwigshafen (DE)

(21) Appl. No.: 12/523,672

(22) PCT Filed: Jan. 17, 2008
(86) PCT No.: PCT/EP2008/050479

§ 371 Date: Jul. 17, 2009

(30) Foreign Application Priority Data
Jan. 19, 2007 (EP) 07100832.0

(51) Int. Cl. B05D 3/06

(52) U.S. Cl. 427/555; 427/554

(57) ABSTRACT

Method for producing structured electrically conductive surfaces on a substrate, which comprises the following steps:
a) structuring a base layer containing electrolessly and/or electrolytically coatable particles on the substrate by ablating the base layer according to a predetermined structure with a laser,
b) activating the surface of the electrolessly and/or electrolytically coatable particles and
c) applying an electrically conductive coating onto the structured base layer.

The invention relates to a method for producing structured electrically conductive surfaces on a substrate.

The method according to the invention is suitable, for example, for producing conductor tracks on printed circuit boards, RFID antennas, transponder antennas or other antenna structures, chip card modules, flat cables, seat heaters, foil conductors, conductor tracks in solar cells or in LCD/plasma screens, or electrolytically coated products in any form. The method according to the invention is also suitable for producing decorative or functional surfaces on products, which may be used for example for shielding electromagnetic radiation, for thermal conduction or as packaging. Lastly, thin metal foils or polymer supports clad on one or two sides may also be produced by the method.

A method for producing patterns on printed circuit boards is known, for example, from DE-A 40 10 244. To this end, a conductive resist is applied onto the generally electrically nonconductive printed circuit board. With the aid of a laser, the conductor pattern is excavated from the conductive resist. The conductor pattern is subsequently metallized. A two-component resist, which contains metal particles, is used as the conductive resist. Iron or nickel powders, for example, are mentioned as suitable metal particles.

A method for producing conductor tracks, in which a printed circuit board is first coated with a conductive ink and the conductor tracks are subsequently modeled from the ink by a laser, is known for example from US-A 2003/0075532. The ink contains a paste, which is laden with conductive particles. For example, metal particles or nonmetallic particles such as carbon particles are mentioned as conductive particles. In order to generate a conductive coating, a thickness of approximately 75 to 100 μm is mentioned.

EP-A 0 415 336 also relates to a method for producing conductor tracks, in which a conductive paste is first applied onto a nonconductor and the conductor tracks are subsequently modeled with a laser. Here again, a large layer thickness is needed in order to generate a conductor track.

In the method for producing conductor tracks on printed circuit boards which is known from EP-A 1 191 127, an activation layer with sufficient electrical conductivity is applied first. The desired conductor track profile is structured thereon with the aid of a laser. Thin metal films, for example, may be applied onto the activation layer. The conductivity of the activation layer is achieved, for example, by using polymerized or copolymerized pyrrole, furan, thiophene or other derivatives. As an alternative, metal sulfide or metal polysulfide layers as well as palladium or copper catalysts may be employed. The disadvantage of many organic activation layers is the low adhesion to many supports and the low thermal stability during application, for example soldering onto printed circuit boards.

A disadvantage of the methods known from the prior art is, on the one hand, that a large layer thickness is needed in order to achieve sufficient conductivity. Owing to the thick layers, high energy consumption is required for the ablation with the aid of the laser. In the methods in which the conductor tracks are subsequently metallized, high energy consumption of the laser is also necessary since a part of the laser radiation is reflected by particles which are contained in the base layer.

Particularly when using very small particles, i.e. particles in the micro- to nanometer range, it is problematic that the particles are embedded in a matrix material and are therefore only to a small extent exposed on the surface. For this reason, the particles are available only to a small extent for electroless and/or electrolytic metallization. A homogeneous, continuous metal coating can therefore be produced only with great difficulty or not at all, so that there is no process reliability. An oxide layer present on the electrically conductive particles will further exacerbate this effect.

It is an object of the invention to provide a simple, cost-effective and productive alternative method by which electrically conductive structured surfaces can be produced on a support, these surfaces being homogeneous and continuously electrically conductive.

The object is achieved by a method for producing structured electrically conductive surfaces on a substrate, which comprises the following steps:
a) structuring a base layer containing electrolessly and/or electrolytically coatable particles on the substrate by ablating the base layer according to a predetermined structure with a laser,
b) activating the surface of the electrolessly and/or electrolytically coatable particles and
c) applying an electrically conductive coating onto the structured base layer.

An advantage of the method according to the invention is that besides two-dimensional circuit structures, for example, it is also possible to provide three-dimensional circuit structures, for example 3D molded interconnected devices or the interior of device packages with conductor tracks having an extremely fine structure. For three-dimensional objects, for example, all the surfaces may be processed in succession either by bringing the object to be coated respectively into the correct position, or by appropriately steering the laser beam.

Rigid or flexible substrates, for example, are suitable as substrates onto which the electrically conductive structured surface is applied.

The substrate is preferably electrically nonconductive. This means that the resistivity is more than 10⁹ ohm×cm. Suitable substrates are for example reinforced or unreinforced polymers, such as those conventionally used for printed circuit boards. Suitable polymers are epoxy resins or modified epoxy resins, for example bifunctional or polyfunctional Bisphenol A or Bisphenol F resins, epoxy-novolak resins, brominated epoxy resins, aramid-reinforced or glass fiber-reinforced or paper-reinforced epoxy resins (for example FR4), glass fiber-reinforced plastics, liquid-crystal polymers (LCP), polyphenylene sulfides (PPS), polyoxymethylenes (POM), polyaryl ether ketones (PAEK), polyether ether ketones (PEEK), polyamides (PA), polycarbonates (PC), polybutylene terephthalates (PBT), polyethylene terephthalates (PET), polyimides (PI), polyimide resins, cyanate esters, bismaleimide-triazine resins, nylon, vinyl ester resins, polyesters, polyester resins, polyamides, polyanilines, phenol resins, polypyrroles, polyethylene naphthalate (PEN), polymethyl methacrylate, polyethylene dioxithiophene, phenolic resin-coated aramid paper, polytetrafluoroethylene (PTFE), melamine resins, silicone resins, fluorine resins, allylated polyphenylene ethers (APPE), polyether imides (PEI), polyphenylene oxides (PPO), polypropylenes (PP), polyethylenes (PE), polysulfones (PSU), polyether sulfones (PES), polyaryl amides (PAA), polyvinyl chlorides (PVC), polystyrenes (PS), acrylonitrile-butadiene-styrene (ABS), acrylonitrile-styrene acrylate (ASA), styrene acrylonitrile (SAN) and mixtures (blends) of two or more of the aforementioned polymers, which may be present in a wide variety of forms. The substrates may comprise additives known to the person skilled in the art, for example flame retardants.

In principle, all polymers mentioned below in respect of the matrix material may also be used. Other substrates likewise conventional in the printed circuit industry are also suitable.

Composite materials, foam-like polymers, Styropor®, Styrodur®, polyurethanes (PU), ceramic surfaces, textiles, pulp, board, paper, polymer-coated paper, wood, mineral materials, silicon, glass, vegetable tissue and animal tissue are furthermore suitable substrates.

A base layer, which contains electrolessly and/or electrolytically coatable particles, is applied onto the substrate. In a first step, the base layer is structured by ablation according to a predetermined structure with a laser. Suitable lasers are commercially available. All lasers may be used, such as pulsed or continuous wave gas, solid state, diode or excimer lasers, so as the base layer absorbs the laser radiation sufficiently and the laser power is sufficient to exceed the ablation threshold, at which the material of the base layer is at least partially decomposed or at least partially vaporized. Pulsed or continuous wave IR lasers are preferably used, for example CO₂ lasers, Nd-YAG lasers, Yb:YAG lasers, fiber or diode lasers. These are available inexpensively and with high power. A suitable laser generally has a power consumption of at least 30 W. Depending on the absorptivity of the base layer, however, it is also possible to use lasers with wavelengths in the visible or UV frequency range. Such lasers are, for example, Ar lasers, HeNe lasers, frequency-multiplied solid state IR lasers or excimer lasers, such as ArF lasers, KrF lasers, XeCl lasers or XeF lasers. As a function of the laser beam source, the laser power, the optics used and the modulators used, the focal diameter of the laser beam lies in the range of between 1 μm and 100 μm, preferably between 5 μm and 50 μm. The wavelength of the laser light preferably lies in the range of from 150 to 10600 nm, particularly preferably in the range of from 600 to 10600 nm.

In a preferred embodiment the regions of the base layer which are to be removed, for example insulation channels in the case of a printed circuit board, are ablated from the base layer by means of a focused laser. It is also possible to generate the structure of the base layer by using a mask arranged in the beam path of the laser or by means of an imaging method.

In a preferred embodiment of the invention a dispersion, which contains electrolessly and/or electrolytically coatable particles in a matrix material, is applied onto the substrate in order to form the base layer before the ablation of the base layer by the laser. The electrolessly and/or electrolytically coatable particles may be particles of arbitrary geometry made of any electrically conductive material, mixtures of different electrically conductive materials or else mixtures of electrically conductive and nonconductive materials. Suitable electrically conductive materials are for example carbon black, for example in the form of carbon black, graphite, graphenes or carbon nanotubes, electrically conductive metal complexes, conductive organic compounds or conductive polymers or metals, preferably zinc, nickel, copper, tin, cobalt, manganese, iron, magnesium, lead, chromium, bismuth, silver, gold, aluminum, titanium, palladium, platinum, tantalum and alloys thereof, or metal mixtures which contain at least one of these metals. Suitable alloys are for example CuZn, CuSn, CuNi, SnPb, SnBi, SnCo, NiPb, SnFe, ZnNi, ZnCo and ZnMn. Aluminum, iron, copper, silver, nickel, zinc, tin, carbon and mixtures thereof are particularly preferred.

The electrolessly and/or electrolytically coatable particles preferably have an average particle diameter of from 0.001 to 100 μm, preferably from 0.005 to 50 μm and particularly preferably from 0.01 to 10 μm. The average particle diameter may be determined by means of laser diffraction measurement, for example using a Microtrac X100 device. The distribution of the particle diameters depends on their production method. The diameter distribution typically comprises only one maximum, although a plurality of maxima are also possible.

If the electrolessly and/or electrolytically coatable particles are employed which exhibit strong reflection in the range of the laser's wavelength being used, then they are preferably provided with a coating. Suitable coatings may be inorganic or organic in nature. Inorganic coatings are for example SiO₂, phosphates or phosphides. The material for the coating will be selected so that it only weakly reflects the laser light being used. The electrolessly and/or electrolytically coatable particles may of course also be coated with a metal or metal oxide, which only weakly reflects the laser light being used. The metal of which the particles consist may also be present in a partially oxidized form. In the case of iron, for example, an iron oxide layer is applied onto the iron particles by oxidizing the iron on the surface. In the case of the carbonyl-iron powder, for example, balls are thereby obtained which consist internally of iron and have an oxide layer on the outer surface.

Owing to the weak reflection of the surface of the particles contained in the base layer, the majority of the laser energy reaches into the base layer. Only the component reflected by the particles is lost for the ablation of the base layer. In this way, the desired structure can be formed from the base layer with little energy outlay.

If two or more different metals are intended to form the electrolessly and/or electrolytically coatable particles, then this may be done by mixing these metals. In particular, it is preferable for the metals to be selected from the group consisting of aluminum, iron, copper, silver, nickel, tin and zinc.

The electrolessly and/or electrolytically coatable particles may nevertheless also contain a first metal and a second metal, the second metal being present in the form of an alloy (with the first metal or one or more other metals), or the electrolessly and/or electrolytically coatable particles contain two different alloys.

Besides the choice of material of the electrolessly and/or electrolytically coatable particles, the shape of the electrolessly and/or electrolytically coatable also has an effect on the properties of the dispersion after coating. In respect of the shape, numerous variants known to the person skilled in the art are possible. The shape of the electrolessly and/or electrolytically coatable particles may, for example, be needle-shaped, cylindrical, platelet-shaped or spherical. These particle shapes represent idealized shapes and the actual shape may differ more or less strongly therefrom, for example owing to production. For example, teardrop-shaped particles are a real deviation from the idealized spherical shape in the scope of the present invention.

Electrolessly and/or electrolytically coatable particles with various particle shapes are commercially available.

When mixtures of electrolessly and/or electrolytically coatable particles are used, the individual mixing partners may also have different particle shapes and/or particle sizes. It is also possible to use mixtures of only one type of electrolessly and/or electrolytically coatable particles with different particle sizes and/or particle shapes. In the case of different particle shapes and/or particle sizes, the metals aluminum, iron, copper, silver, nickel and zinc as well as carbon are likewise preferred.

When mixtures of particle shapes are used, mixtures of spherical particles with platelet-shaped particles are preferred. In one embodiment, for example, spherical carbonyl-iron particles are used with platelet-shaped iron and/or copper particles and/or carbon nanotubes.

As already mentioned above, the electrolessly and/or electrolytically coatable particles may be added to the dispersion in the form of their powder. Such powders, for example metal powders, are commercially available goods and can readily be produced by means of known methods, for instance by electrolytic deposition or chemical reduction from solutions of metal salts or by reduction of an oxidic powder, for example by means of hydrogen, by spraying or atomizing a metal melt, particularly into coolants, for example gases or water. Gas and water atomization and the reduction of metal oxides are preferred. Metal powders with the preferred particle size may also be produced by grinding coarser metal powder. A ball mill, for example, is suitable for this.

Besides gas and water atomization, the carbonyl-iron powder process for producing carbonyl-iron powder is preferred in the case of iron. This is done by thermal decomposition of iron pentacarbonyl. This is described, for example, in Ullman's Encyclopedia of Industrial Chemistry, 5th Edition, Vol. A14, p. 599. The decomposition of iron pentacarbonyl may, for example, take place at elevated temperatures and elevated pressures in a heatable decomposer that comprises a tube of a refractory material such as quartz glass or V2A steel in a preferably vertical position, which is enclosed by a heating instrument, for example consisting of heating baths, heating wires or a heating jacket through which a heating medium flows. Carbonyl-nickel powder can also be produced according to similar method.

Platelet-shaped electrolessly and/or electrolytically coatable particles can be controlled by optimized conditions in the production process or obtained afterwards by mechanical treatment, for example by treatment in an agitator ball mill.

Expressed in terms of the total weight of the dried base layer, the proportion of electrolessly and/or electrolytically coatable particles preferably lies in the range of from 20 to 98 wt. %. A preferred range for the proportion of the electrolessly and/or electrolytically coatable particles is from 30 to 95 wt. % expressed in terms of the total weight of the dried base layer.

For example, binders with a pigment-affine anchor group, natural and synthetic polymers and derivatives thereof, natural resins as well as synthetic resins and derivatives thereof, natural rubber, synthetic rubber, proteins, cellulose derivatives, drying and non-drying oils etc. are suitable as a matrix material. They may—but need not—be chemically or physically curing, for example air-curing, radiation-curing or temperature-curing.

The matrix material is preferably a polymer or polymer blend.

Polymers preferred as a matrix material are, for example, ABS (acrylonitrile-butadiene-styrene); ASA (acrylonitrile-styrene acrylate); acrylic acrylates; alkyd resins; alkyl vinyl acetates; alkyl vinyl acetate copolymers, in particular methylene vinyl acetate, ethylene vinyl acetate, butylene vinyl acetate; alkylene vinyl chloride copolymers; amino resins; aldehyde and ketone resins; celluloses and cellulose derivatives, in particular hydroxyalkyl celluloses, cellulose esters such as acetates, propionates, butyrates, carboxyalkyl celluloses, cellulose nitrate; epoxy acrylate; epoxy resins; modified epoxy resins for example bifunctional or polyfunctional Bisphenol A or Bisphenol F resins, epoxy-novolak resins, brominated epoxy resins, cycloaliphatic epoxy resins; aliphatic epoxy resins, glycidyl ethers, vinyl ethers, ethylene-acrylic acid copolymers; hydrocarbon resins; MABS (transparent ABS also containing acrylate units); melamine resins, maleic acid anhydride copolymers; methacrylates; natural rubber; synthetic rubber; chlorine rubber; natural resins; colophonium resins; shellac; phenolic resins; polyesters; polyester resins such as phenyl ester resins; polysulfones; polyether sulfones; polyamides; polyimides; polyanilines; polypyrroles; polybutylene terephthalate (PBT); polycarbonate (for example Makrolon® from Bayer AG); polyester acrylates; polyether acrylates; polyethylene; polyethylene thiophene; polyethylene naphthalates; polyethylene terephthalate (PET); polyethylene terephthalate glycol (PETG); polypropylene; polymethyl methacrylate (PMMA); polyphenylene oxide (PPO); polystyrenes (PS), polytetrafluoroethylene (PTFE); polytetrahydrofuran; polyethers (for example polyethylene glycol, polypropylene glycol); polyvinyl compounds, in particular polyvinyl chloride (PVC), PVC copolymers, PVdC, polyvinyl acetate as well as copolymers thereof, optionally partially hydrolyzed polyvinyl alcohol, polyvinyl acetals, polyvinyl acetates, polyvinyl pyrrolidone, polyvinyl ethers, polyvinyl acrylates and methacrylates in solution and as a dispersion as well as copolymers thereof, polyacrylates and polystyrene copolymers; polystyrene (modified or not to be shockproof); polyurethanes, uncrosslinked or crosslinked with isocyanates; polyurethane acrylate; styrene acrylic copolymers; styrene butadiene block copolymers (for example Styroflex® or Styrolux® from BASF AG, K-Resin™ from CPC); proteins, for example casein; SIS; triazine resin, bismaleimide triazine resin (BT), cyanate ester resin (CE), allylated polyphenylene ethers (APPE). Mixtures of two or more polymers may also form the matrix material.

Polymers particularly preferred as a matrix material are acrylates, acrylic resins, cellulose derivatives, methacrylates, methacrylic resins, melamine and amino resins, polyalkylenes, polyimides, epoxy resins, modified epoxy resins, for example bifunctional or polyfunctional Bisphenol A or Bisphenol F resins, epoxy-novolak resins, brominated epoxy resins, cycloaliphatic epoxy resins; aliphatic epoxy resins, glycidyl ethers, vinyl ethers and phenolic resins, polyurethanes, polyesters, polyvinyl acetals, polyvinyl acetates, polystyrenes, polystyrene copolymers, polystyrene acrylates, styrene butadiene block copolymers, alkenyl vinyl acetates and vinyl chloride copolymers, polyamides and copolymers thereof.

As a matrix material for the dispersion in the production of printed circuit boards, it is preferable to use thermally or radiation-curing resins, for example modified epoxy resins such as bifunctional or polyfunctional Bisphenol A or Bisphenol F resins, epoxy-novolak resins, brominated epoxy resins, cycloaliphatic epoxy resins; aliphatic epoxy resins, glycidyl ethers, cyanate esters, vinyl ethers, phenolic resins, polyimides, melamine resins and amino resins, polyurethanes, polyesters and cellulose derivatives.

Expressed in terms of the total weight of the dry coating, the proportion of the organic binder components is preferably from 0.01 to 60 wt. %. The proportion is preferably from 0.1 to 45 wt. %, more preferably from 0.5 to 35 wt. %.

In order to be able to apply the dispersion containing the electrolessly and/or electrolytically coatable particles and the matrix material onto the support, a solvent or a solvent mixture may furthermore be added to the dispersion in order to adjust the viscosity of the dispersion suitable for the respective application method.

Suitable solvents are, for example, aliphatic and aromatic hydrocarbons (for example n-octane, cyclohexane, toluene, xylene), alcohols (for example methanol, ethanol, 1-propanol, 2-propanol, 1-butanol, 2-butanol, amyl alcohol), polyvalent alcohols such as glycerol, ethylene glycol, propylene glycol, neopentyl glycol, alkyl esters (for example methyl acetate, ethyl acetate, propyl acetate, butyl acetate, isobutyl acetate, isopropyl acetate, 3-methyl butanol), alkoxy alcohols (for example methoxypropanol, methoxybutanol, ethoxypropanol), alkyl benzenes (for example ethyl benzene, isopropyl benzene), butyl glycol, dibutyl glycol, alkyl glycol acetates (for example butyl glycol acetate, dibutyl glycol acetate, propylene glycol methyl ether acetate), diacetone alcohol, diglycol dialkyl ethers, diglycol monoalkyl ethers, dipropylene glycol dialkyl ethers, dipropylene glycol monoalkyl ethers, diglycol alkyl ether acetates, dipropylene glycol alkyl ether acetate, dioxane, dipropylene glycol and ethers, diethylene glycol and ethers, DBE (dibasic esters), ethers (for example diethyl ether, tetrahydrofuran), ethylene chloride, ethylene glycol, ethylene glycol acetate, ethylene glycol dimethyl ester, cresol, lactones (for example butyrolactone), ketones (for example acetone, 2-butanone, cyclohexanone, methyl ethyl ketone (MEK), methyl isobutyl ketone (MIBK)), dimethyl glycol, methylene chloride, methylene glycol, methylene glycol acetate, methyl phenol (ortho-, meta-, para-cresol), pyrrolidones (for example N-methyl-2-pyrrolidone), propylene glycol, propylene carbonate, carbon tetrachloride, toluene, trimethylol propane (TMP), aromatic hydrocarbons and mixtures, aliphatic hydrocarbons and mixtures, alcoholic monoterpenes (for example terpineol), water and mixtures of two or more of these solvents.

Preferred solvents are alcohols (for example ethanol, 1-propanol, 2-propanol, 1-butanol), alkoxyalcohols (for example methoxy propanol, ethoxy propanol, butyl glycol, dibutyl glycol), butyrolactone, diglycol dialkyl ethers, diglycol monoalkyl ethers, dipropylene glycol dialkyl ethers, dipropylene glycol monoalkyl ethers, esters (for example ethyl acetate, butyl acetate, butyl glycol acetate, dibutyl glycol acetate, diglycol alkyl ether acetates, dipropylene glycol alkyl ether acetates, DBE, propylene glycol methyl ether acetate), ethers (for example tetrahydrofuran), polyvalent alcohols such as glycerol, ethylene glycol, propylene glycol, neopentyl glycol, ketones (for example acetone, methyl ethyl ketone, methyl isobutyl ketone, cyclohexanone), hydrocarbons (for example cyclohexane, ethyl benzene, toluene, xylene), N-methyl-2-pyrrolidone, water and mixtures thereof.

In the case of liquid matrix materials (for example liquid epoxy resins, acrylic esters), the respective viscosity may alternatively be adjusted via the temperature during application, or via a combination of a solvent and temperature.

The dispersion may furthermore contain a dispersant component. This consists of one or more dispersants.

In principle, all dispersants known to the person skilled in the art for application in dispersions and described in the prior art are suitable. Preferred dispersants are surfactants or surfactant mixtures, for example anionic, cationic, amphoteric or nonionic surfactants.

Cationic and anionic surfactants are described, for example, in “Encyclopedia of Polymer Science and Technology”, J. Wiley & Sons (1966), Vol. 5, pp. 816-818, and in “Emulsion Polymerisation and Emulsion Polymers”, ed. P. Lovell and M. El-Asser, Wiley & Sons (1997), pp. 224-226. It is nevertheless also possible to use polymers known to the person skilled in the art having pigment-affine anchor groups as dispersants.

The dispersant may be used in the range of from 0.01 to 50 wt. %, expressed in terms of the total weight of the dispersion. The proportion is preferably from 0.1 to 20 wt. %, particularly preferably from 0.2 to 10 wt. %.

The dispersion according to the invention may furthermore contain a filler component. This may consist of one or more fillers. For instance, the filler component of the metallizable mass may contain fillers in fiber, layer or particle form, or mixtures thereof. These are preferably commercially available products, for example carbon and mineral fillers.

It is furthermore possible to use fillers or reinforcers such as glass powder, mineral fibers, whiskers, aluminum hydroxide, metal oxides such as aluminum oxide or iron oxide, mica, quartz powder, calcium carbonate, barium sulfate, titanium dioxide or wollastonite.

Other additives may furthermore be used, such as thixotropic agents, for example silica, silicates, for example aerosils or bentonites, or organic thixotropic agents and thickeners, for example polyacrylic acid, polyurethanes, hydrated castor oil, dyes, fatty acids, fatty acid amides, plasticizers, networking agents, defoaming agents, lubricants, desiccants, crosslinkers, photoinitiators, sequestrants, waxes, pigments, conductive polymer particles.

The proportion of the filler component is preferably from 0.01 to 50 wt. %, expressed in terms of the total weight of the dry coating. From 0.1 to 30 wt. % are further preferred, and from 0.3 to 20 wt. % are particularly preferred.

There may furthermore be processing auxiliaries and stabilizers in the dispersion according to the invention, such as UV stabilizers, lubricating agents, corrosion inhibitors and flame retardants. Their proportion is usually from 0.01 to 5 wt. %, expressed in terms of the total weight of the dispersion. The proportion is preferably from 0.05 to 3 wt. %.

If the electrolessly and/or electrolytically coatable particles in the dispersion on the support cannot themselves sufficiently absorb the energy of the energy source, for example the laser, absorbents may be added to the dispersion. Depending on the laser beam source used, it may be necessary to select different absorbents. In this case either the absorbent is added to the dispersion or an additional separate absorbent layer is applied between the support and the dispersion. In the latter case, the energy is absorbed locally in the absorption layer and transferred to the dispersion by thermal conduction.

Suitable absorbents for laser radiation have a high absorption in the range of the laser wavelength. In particular, absorbents which have a high absorption in the near infrared and in the longer-wave VIS range of the electromagnetic spectrum are suitable. Such absorbents are suitable in particular for absorbing the radiation of high-power solid-state lasers, for example Nd-YAG lasers which have a wavelength of 1064 nm, or IR diode lasers which typically have wavelengths in the range of from 700 to 1600 nm. Examples of suitable absorbents for laser irradiation dyes absorbing strongly in the infrared spectral range, for example phthalocyanines, naphthalocyanines, cyanines, quinones, metal complex dyes, such as dithiolenes or photochromic dyes.

Other suitable absorbents are inorganic pigments, in particular intensely colored inorganic pigments such as chromium oxides, iron oxides, iron oxide hydrates or carbon, for example in the form of carbon black, graphite, graphenes or carbon nanotubes.

Finely divided types of carbon and finely divided lanthanum hexaboride (LaB₆) are particularly suitable as absorbents for laser radiation.

In general, from 0.005 to 20 wt. % of absorbent are used, expressed in terms of the weight of the electrolessly and/or electrolytically coatable particles in the dispersion. Preferably from 0.01 to 15 wt. % of absorbent and particularly preferably from 0.01 to 10 wt. % are used, expressed in terms of the weight of the electrolessly and/or electrolytically coatable particles in the dispersion.

The amount of absorbent added will be selected by the person skilled in the art according to the respectively desired properties of the dispersion layer. In this context, the person skilled in the art will furthermore take into account the fact that the added absorbents affect not only the rate and efficiency of the laser ablation of the base layer, but also other properties of the base layer, for example the support adhesion, curing or the electroless or metal adhesion.

In the case of a separate absorption layer, in the most favorable case this contains the absorbent and the same matrix material as the overlying base layer, in order to ensure good layer adhesion. In order to induce effective conversion of light energy into heat energy and achieve rapid thermal conduction into the base layer, the absorption layer should be applied as thinly as possible and the absorbent should be present in as high as possible a concentration, without detrimentally affecting the layer properties such as example adhesion to the support and the base layer, and the curing. Suitable concentrations of the absorbent in the absorption layer are in this case at least 1 to 95 wt. %, from 50 to 85 wt. % being particularly preferred.

The energy, which is needed for the ablation, may be applied either on the site coated with the dispersion or on the opposite side of the substrate from the dispersion, as a function of the substrate being used. The ablation may be removed with the aid of suction or by blowing off the ablation. If need be, a combination of the two method variants may be used.

The coating of the substrate with the base layer may be carried out either on one side or on both sides. The two sides may be structured in succession or by means of at least two laser beam sources in the laser ablation step, or even on both sides simultaneously.

In order to increase productivity, more than one laser beam source may also be used. It is also possible to split the laser beam of a laser source, so that the productivity can likewise be increased with only one laser source.

The structuring may, for example, be achieved either by moving the substrate on an XY stage or by the laser beam being moved, for example by using a mobile mirror. A combination of the two methods is also possible.

The application of the surface-wide base layer is carried out, for example, according to the coating method known to the person skilled in the art. Such coating methods are, for example, casting, painting, doctor blading, brushing, spraying, immersion, rolling, powdering, fluidized bed or the like. As an alternative, the surface-wide base layer with the dispersion is printed onto the support by any printing method, in which case the future structures may be preformed coarsely. The printing method, by which the base layer is printed on, is for example a roller or sheet printing method, for example screen printing, direct or indirect intaglio printing, flexographic printing, typography, pad printing, inkjet printing, the Laser-Sonic® method as described DE 100 51 850, offset printing or magnetographic printing method. Any other printing method known to the person skilled in the art may, however, also be used. The layer thickness of the base layer generated by the printing or the coating method preferably varies between 0.01 and 50 μm, more preferably between 0.05 and 25 μm and particularly preferably between 0.1 and 20 μm. The layers may be applied either surface-wide or in a structured way. The layers may be applied on one side or also, if need be, on both sides.

Structured application of the dispersion is advantageous and preferred when, for example, predetermined structures are intended to be produced in large batch numbers, and the size of the area to be ablated is reduced by the structured application. In this way, production can be carried out with a higher rate and also more cost-effectively since less material of the base layer needs to be ablated.

The dispersion is preferably stirred or pumped around in a storage container before application onto the substrate. Stirring and/or pumping prevents possible sedimentation of the particles contained in the dispersion. By preventing sedimentation, more homogeneous base layers are obtained, i.e. base layers in which the electrically conductive particles are distributed homogeneously. A maximally homogeneous base layer leads to significantly better, more homogeneous and more continuous structures in the electroless and/or electrolytic coating step.

Furthermore, it is likewise advantageous for the dispersion to be thermally regulated in the storage container. This makes it possible to achieve a more homogeneous base layer on the support, since a constant viscosity can be adjusted by the thermal regulation. Thermal regulation is necessary in particular whenever, for example, the dispersion is heated by the energy input of the stirrer or pump when stirring and/or pumping and its viscosity therefore changes.

Besides coating the substrate on one side, with the method according to the invention it is also possible to provide the support with an electrically conductive structured surface on its upper side and its lower side. With the aid of vias, the structured electrically conductive surfaces on the upper side and the lower side of the substrate can be electrically connected together. For the via contacting, for example, a wall of a bore in the substrate is provided with an electrically conductive surface. In order to produce the via contacting it is possible to form bores in the support, for example, onto the walls of which the dispersion that contains the electrolessly and/or electrolytically coatable particles is applied. With a sufficiently thin substrate, for example a thin PET sheet, it is not necessary to coat the wall of the bore with the dispersion since, with a sufficiently long coating time, a metal layer also forms inside the bore during the electroless and/or electrolytic coating by the metal layers growing together into the bore from the upper and lower sides of the substrate, so that an electrical connection of the electrically conductive structured surfaces of the upper and lower sides of the support is created. Besides the method according to the invention, it is also possible to use other methods known from the prior art for the metallization of bores and/or blind holes.

In the case of thin supports, for example, the boring may be produced by slitting, punching or by laser boring.

In order to obtain a mechanically stable base layer on the substrate, it is preferable for the dispersion, with which the base layer is applied onto the substrate, to be at least partially dried and/or at least partially cured after the application. As a function of the matrix material, the drying and/or curing is carried out as described above, for example by the action of heat, light (UV/Vis) and/or radiation, for example infrared radiation, electron radiation, gamma radiation, X-radiation, microwaves. In order to initiate the curing reaction, a suitable activator may need to be added. The curing may also be achieved by a combination of different methods, for example by a combination of UV radiation and heat. The curing methods may be combined simultaneously or successively. For example, the layer may first be only partially cured by UV radiation, so that the structures formed no longer flow apart. The layer may subsequently be cured by the action of heat. The heating may in this case take place directly after the UV curing and/or after the electroless and/or electrolytic metallization. After at least partially drying and/or curing and exposure of the desired structure by means of ablation, in a preferred variant the electrolessly and/or electrolytically coatable particles may be at least partially exposed.

By exposing the electrolessly and/or electrolytically coatable particles, additional seeds for the metallization are generated so that a more homogeneous and more continuous metal layer is created.

The electrolessly and/or electrolytically coatable particles may be exposed either mechanically, for example by brushing, grinding, milling, sandblasting or blasting with supercritical carbon dioxide, physically, for example by heating, laser, UV light, corona or plasma discharge, or chemically. In the case of chemical exposure, it is preferable to use a chemical or chemical mixture which is compatible with the matrix material. In the case of chemical exposure, either the matrix material may be at least partially dissolved on the surface and washed away, for example by a solvent, or the chemical structure of the matrix material may be at least partially disrupted by means of suitable reagents so that the electrolessly and/or electrolytically coatable particles are exposed. Reagents which make the matrix material tumesce are also suitable for exposing the electrolessly and/or electrolytically coatable particles. The tumescence creates cavities which the metal ions to be deposited can enter from the electrolyte solution, so that a larger number of electrolessly and/or electrolytically coatable particles can be metallized. The bonding, homogeneity and continuity of the metal layer subsequently deposited electrolessly and/or electrolytically is significantly better than in the methods described in the prior art. The process rate during the metallization is also higher because of the larger number of exposed electrolessly and/or electrolytically coatable particles, so that additional cost advantages can be achieved.

If the matrix material is for example an epoxy resin, a modified epoxy resin, an epoxy-novolak, a polyacrylate, ABS, a styrene-butadiene copolymer or a polyether, the electrolessly and/or electrolytically coatable particles are preferably exposed by using an oxidant. The oxidant breaks bonds of the matrix material, so that the binder can be dissolved and the particles can thereby be exposed. Suitable oxidants are, for example, manganates such as for example potassium permanganate, potassium manganate, sodium permanganate, sodium manganate, hydrogen peroxide, oxygen, oxygen in the presence of catalysts such as for example manganese salts, molybdenum salts, bismuth salts, tungsten salts and cobalt salts, ozone, vanadium pentoxide, selenium dioxide, ammonium polysulfide solution, sulfur in the presence of ammonia or amines, manganese dioxide, potassium ferrate, dichromate/sulfuric acid, chromic acid in sulfuric acid or in acetic acid or in acetic anhydride, nitric acid, hydroiodic acid, hydrobromic acid, pyridinium dichromate, chromic acid-pyridine complex, chromic acid anhydride, chromium(VI) oxide, periodic acid, lead tetraacetate, quinone, methylquinone, anthraquinone, bromine, chlorine, fluorine, iron(III) salt solutions, disulfate solutions, sodium percarbonate, salts of oxohalic acids such as for example chlorates or bromates or iodates, salts of perhalic acids such as for example sodium periodate or sodium perchlorate, sodium perborate, dichromates such as for example sodium dichromate, salts of persulfuric acids such as potassium peroxodisulfate, potassium peroxomonosulfate, pyridinium chlorochromate, salts of hypohalic acids, for example sodium hypochloride, dimethyl sulfoxide in the presence of electrophilic reagents, tert-butyl hydroperoxide, 3-chloroperbenzoate, 2,2-dimethylpropanal, Des-Martin periodinane, oxalyl chloride, urea hydrogen peroxide adduct, urea hydrogen peroxide, 2-iodoxybenzoic acid, potassium peroxomonosulfate, m-chloroperbenzoic acid, N-methylmorpholine-N-oxide, 2-methylprop-2-yl hydroperoxide, peracetic acid, pivaldehyde, osmium tetraoxide, oxone, ruthenium(III) and (IV) salts, oxygen in the presence of 2,2,6,6-tetramethylpiperidinyl-N-oxide, triacetoxiperiodinane, trifluoroperacetic acid, trimethyl acetaldehyde, ammonium nitrate. The temperature during the process may optionally be increased in order to improve the exposure process.

Preferred are manganates, for example potassium permanganate, potassium manganate, sodium permanganate, sodium manganate, hydrogen peroxide, N-methylmorpholine-N-oxide, percarbonates, for example sodium or potassium percarbonate, perborates, for example sodium or potassium perborate, persulfates, for example sodium or potassium persulfate, sodium, potassium and ammonium peroxodi- and monosulfates, sodium hydrochloride, urea hydrogen peroxide adducts, salts of oxohalic acids such as for example chlorates or bromates or iodates, salts of perhalic acids such as for example sodium periodate or sodium perchlorate, tetrabutylammonium peroxidisulfate, quinone, iron(III) salt solutions, vanadium pentoxide, pyridinium dichromate, hydrochloric acid, bromine, chlorine, dichromates.

Particularly preferred are potassium permanganate, potassium manganate, sodium permanganate, sodium manganate, hydrogen peroxide and its adducts, perborates, percarbonates, persulfates, peroxodisulfates, sodium hypochloride and perchlorates.

In order to expose the electrolessly and/or electrolytically coatable particles in a matrix material which contains for example ester structures such as polyester resins, polyester acrylates, polyether acrylates, polyester urethanes, it is preferable for example to use acidic or alkaline chemicals and/or chemical mixtures. Preferred acidic chemicals and/or chemical mixtures are, for example, concentrated or dilute acids such as hydrochloric acid, sulfuric acid, phosphoric acid or nitric acid. Organic acids such as formic acid or acetic acid may also be suitable, depending on the matrix material. Suitable alkaline chemicals and/or chemical mixtures are, for example, bases such as sodium hydroxide, potassium hydroxide, ammonium hydroxide or carbonates, for example sodium carbonate or calcium carbonate. The temperature during the process may optionally be increased in order to improve the exposure process.

Solvents may also be used to expose the electrolessly and/or electrolytically coatable particles in the matrix material. The solvent must be adapted to the matrix material, since the matrix material must dissolve in the solvent or be tumesced by the solvent. When using a solvent in which the matrix material dissolves, the base layer is brought in contact with the solvent only for a short time so that the upper layer of the matrix material is solvated and thereby dissolved. Preferred solvents are xylene, toluene, halogenated hydrocarbons, acetone, methyl ethyl ketone (MEK), methyl isobutyl ketone (MIBK), diethylene glycol monobutyl ether. The temperature during the dissolving process may optionally be increased in order to improve the dissolving behavior.

Furthermore, it is also possible to expose the electrolessly and/or electrolytically coatable particles by using a mechanical method. Suitable mechanical methods are, for example, brushing, grinding, polishing with an abrasive or pressure blasting with a water jet, sandblasting or blasting with supercritical carbon dioxide. The top layer of the cured, printed structured base layer is respectively removed by such a mechanical method. The electrolessly and/or electrolytically coatable particles contained in the matrix material are thereby exposed.

All abrasives known to the person skilled in the art may be used as abrasives for polishing. A suitable abrasive is, for example, pumice powder.

In order to remove the top layer of the cured dispersion by pressure blasting with a water jet, the water jet preferably contains small solid particles, for example pumice powder (Al₂O₃) with an average particle size distribution of from 40 to 120 μm, preferably from 60 to 80 μm, as well as quartz powder (SiO₂) with a particle size >3 μm.

If the electrolessly and/or electrolytically coatable particles contain a material which can readily be oxidized, in a preferred method variant the oxide layer is at least partially removed before the metal layer is formed on the base layer. The oxide layer may in this case be removed chemically and/or mechanically, for example. Suitable substances with which the base layer can be treated in order to chemically remove an oxide layer from the electrolessly and/or electrolytically coatable particles are, for example, acids such as concentrated or dilute sulfuric acid or concentrated or dilute hydrochloric acid, citric acid, phosphoric acid, amidosulfonic acid, formic acid, acetic acid.

Suitable mechanical methods for removing the oxide layer from the electrolessly and/or electrolytically coatable particles are generally the same as the mechanical methods for exposing the particles.

So that the dispersion adheres firmly on the substrate, in a preferred embodiment the latter is cleaned by a dry method, a wet chemical method and/or a mechanical method before applying the base layer. By the wet chemical and mechanical methods, it is in particular also possible to roughen the surface of the support so that the dispersion bonds to it better. A suitable wet chemical method is, in particular, washing the support with acidic or alkaline reagents or with suitable solvents. Water may also be used in conjunction with ultrasound. Suitable acidic or alkaline reagents are, for example, hydrochloric acid, sulfuric acid or nitric acid, phosphoric acid, or sodium hydroxide, potassium hydroxide or carbonates such as potassium carbonate. Suitable solvents are the same as those which may be contained in the dispersion for applying the base layer. Preferred solvents are alcohols, ketones and hydrocarbons, which need to be selected as a function of the support material. The oxidants which have already been mentioned for the activation may also be used.

Mechanical methods with which the support can be cleaned before applying the structured or full-surface base layer are generally the same as those which may be used to expose the electrolessly and/or electrolytically coatable particles and to remove the oxide layer of the particles.

Dry cleaning methods in particular are suitable for removing dust and other particles which can affect the bonding of the dispersion on the support, and for roughening the surface. These are, for example, dust removal by means of brushes and/or deionized air, corona discharge or low-pressure plasma as well as particle removal by means of rolls and/or rollers, which are provided with an adhesive layer.

By corona discharge and low-pressure plasma, the surface tension of the substrate can be selectively increased, organic residues can be cleaned from the substrate surface, and therefore both the wetting with the dispersion and the bonding of the dispersion can be improved.

In order to improve the adhesion of the applied base layer on the substrate, according to requirements, the substrate may be provided with an additional bonding or adhesive layer by methods known to the person skilled in the art before the base layer is transferred.

After application and at least partial curing and/or drying of the base layer, the structure is excavated by ablation. To this end, the parts of the base layer which are not part of the structure are removed. The removal is carried out according to the invention with the aid of a laser beam. By the energy input with the laser beam, at least the matrix material of the base layer is at least partially decomposed and/or vaporized. The electrolessly and/or electrolytically coatable particles contained in the matrix material are thereby also exposed. The material removed from the base layer may be suctioned and/or blown off.

If conductor tracks are intended to be produced by the method according to the invention, then in one embodiment, in addition to the desired conductor track structure, it is also possible to expose contact lines, which are connected to the conductor track structure, by the laser ablation method. These auxiliary contacting lines are further processed just like the desired structure of the conductor tracks. To this end, the contacting lines exposed by laser ablation are likewise metallized electrolessly and/or electrolytically after having exposed the electrolessly and/or electrolytically coatable particles contained on the surface. The contacting lines are used, for example, so that even short, mutually insulated conductor tracks can be readily contacted. In a preferred embodiment, the auxiliary contacting lines are at least partially removed again after the electroless and/or electrolytic metallization. The removal may for example be carried out by laser ablation.

After having structured the base layer by laser ablation, an electrically conductive coating is applied onto the structured base layer. In order to generate the electrically conductive surface, at least one metal layer is formed on the structured base layer by electroless and/or electrolytic coating after having exposed the electrically conductive particles. The coating may be carried out by any method known to the person skilled in the art. Any conventional metal coating may moreover be applied using the coating method. In this case, the composition of the electrolyte solution, which is used for the coating, depends on the metal with which the electrically conductive structures on the substrate are intended to be coated. In principle, all metals which are nobler than or equally noble as the least noble metal of the dispersion may be used for the electroless and/or electrolytic coating. Conventional metals which are deposited onto electrically conductive surfaces by electroless and/or electrolytic coating are, for example, gold, nickel, palladium, platinum, silver, tin, copper or chromium. The thicknesses of the one or more deposited layers lie in the conventional ranges known to the person skilled in the art.

Suitable electrolyte solutions, which are used for coating electrically conductive structures, are known to the person skilled in the art for example from Werner Jillek, Gustl Keller, Handbuch der Leiterplattentechnik [Handbook of printed circuit technology]. Eugen G. Leuze Verlag, 2003, volume 4, pages 332-352.

In order to coat the electrically conductive structured surface on the substrate, the substrate is first sent to the bath of the electrolyte solution. The substrate is then transported through the bath, the electrolessly and/or electrolytically coatable particles contained in the previously applied structured base layer being contacted by at least one cathode. Here, any suitable conventional cathode known to the person skilled in the art may be used. As long as the cathode contacts the structured surface, metal ions are deposited from the electrolyte solution to form a metal layer on the base layer. The contacting may also take place via the auxiliary contacting lines. Usually, a thin layer of the base layer is formed immediately by electroless deposition when immersed into the electrolyte solution.

If the base layer itself is not sufficiently conductive, for example when using carbon carbonyl-iron powder as electrolessly and/or electrolytically coatable particles, then the conductivity required for the electrolytic coating is achieved by this electrolessly deposited layer.

A suitable device, in which the structured electrically conductive base layer can be electrolytically coated, generally comprises at least one bath, one anode and one cathode, the bath containing an electrolyte solution containing at least one metal salt. Metal ions from the electrolyte solution are deposited onto electrically conductive surfaces of the substrate or the base layer to form a metal layer. To this end, the at least one cathode is brought in contact with the substrate's base layer to be coated, while the substrate is transported through the bath.

All electrolytic methods known to the person skilled in the art are suitable for the electrolytic coating in this case. Such electrolytic methods are, for example, those in which the cathode is formed by one or more rollers which contact the material to be coated. The cathodes may also be designed in the form of segmented rollers, in which at least the roller segment which is in communication with the substrate to be coated is respectively connected cathodically. In order that the deposited metal on the roller is removed again, in the case of segmented rollers it is possible to anodically connect the segments which do not contact the base layer to be coated, so that the metal deposited on them is deposited into the electrolyte solution.

When using auxiliary contacting lines, the auxiliary contacting lines are contacted by the cathode for the electrolytic coating. The contacting lines are used, for example, so that even short, mutually insulated conductor tracks can be readily contacted. The auxiliary contacting lines are preferably removed again after the electrolytic coating. For example, the auxiliary contacting lines may also be removed by laser ablation. To this end, for example, the same laser beam sources are used as for generating the structure of the base layer.

The electrolytic coating device may furthermore be equipped with a device by which the substrate can be rotated. The rotation axis of the device, by which the substrate can be rotated, is in this case arranged perpendicularly to the substrate's surface to be coated. Electrically conductive structures which are initially wide and short as seen in the transport direction of the substrate, are aligned by the rotation so that they are narrow and long as seen in the transport direction after the rotation.

The layer thickness of the metal layer deposited on the electrolessly and/or electrolytically coatable structure by the method according to the invention depends on the contact time, which is given by the speed with which the substrate passes through the device and the number of cathodes positioned in series, as well as the current strength with which the device is operated. A longer contact time may be achieved, for example, by connecting a plurality of devices according to the invention in series in at least one bath.

In order to permit simultaneous coating of the upper and lower sides, for example, two contacting rollers may respectively be arranged so that the substrate to be coated can be guided through between them.

When the intention is to coat flexible foils whose length exceeds the length of the bath, so-called endless foils which are first unwound from a roll, guided through the electrolytic coating device and then wound up again, they may for example be guided through the bath in a zigzag shape or in the form of a meander around a plurality of electrolytic coating devices, which for example may then also be arranged above one another or next to one another.

The electrolytic coating device may, if necessary, be equipped with any auxiliary device known to the person skilled in the art. Such auxiliary devices are, for example, pumps, filters, supply instruments for chemicals, winding, unwinding instruments etc.

All methods of treating the electrolyte solution known to the person skilled in the art may be used in order to shorten the maintenance intervals. Such treatment methods, for example, are also systems in which the electrolyte solution self-regenerates.

The device according to the invention may also be operated, for example, in the pulse method known from Werner Jillek, Gustl Keller, Handbuch der Leiterplattentechnik [Handbook of printed circuit technology], Eugen G. Leuze Verlag, 2003, volume 4, pages 192, 260, 349, 351, 352, 359.

After the electrolytic coating, the substrate may be processed further according to all steps known to the person skilled in the art. For example, existing electrolyte residues may be removed from the substrate by washing and/or the substrate may be dried.

The method according to the invention for producing electrically conductive structured surfaces on a support may be operated in a continuous, semicontinuous or discontinuous mode. It is also possible for only individual steps of the method to be carried out continuously, while other steps are carried out discontinuously.

After the electrolytic coating, the substrate may be processed further according to all steps known to the person skilled in the art. For example, existing electrolyte residues may be removed from the substrate by washing and/or the substrate may be dried.

The method according to the invention is suitable, for example, for the production of conductor tracks on printed circuit boards. Such printed circuit boards are, for example, those with multilayer inner and outer levels, micro-via-chip-on-board, flexible and rigid printed circuit boards. These are for example installed in products such as computers, telephones, televisions, electrical automobile components, keyboards, radios, video, CD, CD-ROM and DVD players, game consoles, measuring and regulating equipment, sensors, electrical kitchen appliances, electrical toys etc.

Electrically conductive structures on flexible circuit supports may also be coated with the method according to the invention. Such flexible circuit supports are, for example, plastic sheets made of the aforementioned materials mentioned for the supports, onto which electrically conductive structures are printed. The method according to the invention is furthermore suitable for producing RFID antennas, transponder antennas or other antenna structures, chip card modules, flat cables, seat heaters, foil conductors, conductor tracks in solar cells or in LCD/plasma screens, capacitors, foil capacitors, resistors, convectors, electrical fuses or for producing electrically coated products in any form, for example polymer supports clad with metal on one or two sides with a defined layer thickness, 3D molded interconnected devices or for producing decorative or functional surfaces on products, which are used for example for shielding electromagnetic radiation, for thermal conduction or as packaging. It is furthermore possible to produce contact points or contact pads or interconnections on an integrated electronic component.

The production of integrated circuits, resisted, capacity four inductive elements, diodes, transistors, sensors, actuators, optical components and receiver/transmission devices is also possible with the method according to the invention.

It is furthermore possible to produce antennas with contacts for organic electronic components, as well as coatings on surfaces consisting of electrically nonconductive material for electromagnetic shielding.

Use is furthermore possible in the context of flow fields of bipolar plates for application in fuel cells.

It is furthermore possible to produce a full-area or structured electrically conductive layer for subsequent decor metallization of shaped articles made of the aforementioned electrically nonconductive substrate.

The application range of the method according to the invention allows inexpensive production of metallized, even nonconductive substrates, particularly for use as switches and sensors, gas barriers or decorative parts, in particular decorative parts for the motor vehicle, sanitary, toy, household and office sectors, and packaging as well as foils. The invention may also be applied in the field of security printing for banknotes, credit cards identity documents etc. Textiles may be electrically and magnetically functionalized with the aid of the method according to the invention (antennas, transmitters, RFID and transponder antennas, sensors, heating elements, antistatic (even for plastics), shielding etc.).

It is furthermore possible to produce thin metal foils, or polymer supports clad on one or two sides, or metallized plastic surfaces, for example trim strips or exterior mirrors.

The method according to the invention may likewise be used for the metallization of holes, vias, blind holes etc., for example in printed circuit boards, RFID antennas or transponder antennas, flat cables, foil conductors with a view to via contacting the upper and lower sides. This also applies when other substrates are used.

The metallized articles produced according to the invention—if they comprise magnetizable metals—may also be employed in the field of magnetizable functional parts such as magnetic tables, magnetic games, magnetic surfaces for example on refrigerator doors. They may also be employed in fields in which good thermal conductivity is advantageous, for example in foils for seat heaters, as well as insulation materials.

Preferred uses of the surfaces metallized according to the invention are those in which the products produced in this way are used as printed circuit boards, RFID antennas, transponder antennas, seat heaters, flat cables, contactless chip cards, 3D molded interconnect devices, thin metal foils or polymer supports clad on one or two sides, foil conductors, conductor tracks in solar cells or in LCD/plasma screens, integrated circuits, resistive, capacitive or inductive elements, diodes, transistors, sensors, actuators, optical components, receiver-transmission devices, or as decorative application, for example for packaging materials.

1. A method for producing structured electrically conductive surfaces on a substrate, which comprises the following steps:
a) structuring a base layer containing electrolessly and/or electrolytically coatable particles on the substrate by ablating the base layer according to a predetermined structure with a laser, wherein the electrolessly and/or electrolytically coatable particles are provided with a coating, which reflects the laser light only weakly or consists of a material which reflects the laser light only weakly,
b) activating the surface of the electrolessly and/or electrolytically coatable particles and
c) applying an electrically conductive coating onto the structured base layer.

2. The method as claimed in claim 1, wherein a dispersion, which contains the electrolessly and/or electrolytically coatable particles, is applied onto the substrate in order to form the base layer before the ablation of the base layer by the laser.

3. The method as claimed in claim 2, wherein the application of the dispersion in order to form the base layer is carried out by a printing, casting, rolling, immersion or spray method.

4. The method as claimed in claim 2, wherein the dispersion is stirred and/or pumped around and/or thermally regulated in a storage container before application.

5. The method as claimed in claim 1, wherein the dispersion applied onto the substrate is at least partially dried and/or cured.

6. The method as claimed in claim 5, wherein the at least partial drying or curing of the dispersion is carried out before the ablation with the laser or after the ablation with the laser.

7. The method as claimed in claim 1, wherein the laser is a solid state laser, a fiber laser, a diode laser, a gas laser or an excimer laser.

8. The method as claimed in claim 1, wherein the wavelength of the laser light lies in the range between 150 and 10600 nm, preferably in the range between 600 and 10600 nm.

9. The method as claimed in claim 1, wherein the electrolessly and/or electrolytically coatable particles contain at least one metal powder, carbon or a mixture thereof.

10. The method as claimed in claim 9, wherein the metal of the metal powder is selected from iron, nickel, silver, tin, zinc or copper.

11. The method as claimed in claim 9, wherein the metal powder is a carbonyl-iron powder.

12. The method as claimed in claim 2, wherein the dispersion contains an absorbent for laser light.

13. The method as claimed in claim 12, wherein the absorbent is carbon or lanthanum hexaboride.

14. The method as claimed in claim 1, wherein the electrolessly and/or electrolytically coatable particles have different particle geometries.

15. The method as claimed in claim 1, wherein the electrolessly and/or electrolytically coatable particles contained in the dispersion are chemically, physically or mechanically exposed before the electroless and/or electrolytic coating.

16. The method as claimed in claim 1, wherein any existing coating is removed from the electrolessly and/or electrolytically coatable particles in order to activate the surface of the electrolessly and/or electrolytically coatable particles.

17. The method as claimed in claim 2, wherein the substrate is cleaned by a dry method, a wet chemical method and/or a mechanical method before the application of the dispersion which contains the electrolessly and/or electrolytically coatable particles.

18. The method as claimed in claim 1, wherein a structured electrically conductive surface is applied onto the upper side and the lower side of the support.

19. The method as claimed in claim 18, wherein the structured electrically conductive surfaces on the upper side and the lower side of the support are connected together by via contacting.

20. The method as claimed in claim 1, wherein the electrically conductive coating is applied electrolessly and/or electrolytically onto the base layer.

21. The method as claimed in claim 20, wherein the base layer is connected for the electrolytic coating to auxiliary contacting lines which are contacted by at least one cathode.

22. The method as claimed in claim 1 for producing conductor tracks on printed circuit boards, RFID antennas, transponder antennas or other antenna structures, chip card modules, flat cables, seat heaters, foil conductors, conductor tracks in solar cells or in LCD/plasma screens, 3D molded interconnected devices, integrated circuits, resistive, capacitive or inductive elements, diodes, transistors, sensors, actuators, optical components, receiver/transmission devices, decorative or functional surfaces on products, which are used for shielding electromagnetic radiation, for thermal conduction or as packaging, thin metal foils or polymer supports clad on one or two sides, or for producing electrolytically coated products in any form.
